(19) United States
(12) Patent Application Publication
(10) Pub. No.: US 2013/0294426 A1
(43) Pub. Date: Nov. 7, 2013

(54) PROVIDING CONNECTIVITY TO END DEVICES USING WIRELESS LOCAL AREA NETWORK TECHNOLOGIES

(71) Applicants: Pankaj Vyas, Bangalore (IN); Vishal Batra, Bangalore (IN)

(72) Inventors: Pankaj Vyas, Bangalore (IN); Vishal Batra, Bangalore (IN)

(73) Assignee: GainSpan Corporation, San Jose, CA (US)

(21) Appl. No.: 13/462,852

(22) Filed: May 3, 2012

(51) Int. Cl. H04W 84/12

(52) U.S. Cl. 370/338

(57) ABSTRACT

An end device operates as an access point to setup communication with a wireless station. Once the communication has been setup, the end device exchanges data packets with the wireless station while operating as an access point. The end device and the wireless station are included in a WLAN network according to IEEE 802.11 standards. Operation as an access point enables the end device to communicate with a large number of wireless stations. Such communication can be the basis for implementation of various management applications on wireless stations. In an embodiment, the end point includes a blood pressure sensor, and transmits (while operating as an access point) blood pressure measurements to a mobile phone operating as a wireless station.

### RELATED APPLICATION

The present invention is related to application number: (not yet assigned), entitled, “REDUCING POWER CONSUMPTION IN A DEVICE OPERATING AS AN ACCESS POINT OF A WIRELESS LOCAL AREA NETWORK”, naming as inventors: Pankaj Vyas, Venu Kosuri and Vishal Batra, attorney docket number: GSPN-008-US, filed on even date herewith, and is incorporated into the subject patent application in its entirety.

### BACKGROUND OF THE INVENTION

1. Technical Field

Embodiments of the present disclosure relate generally to wireless networks, and more specifically to providing connectivity to end devices using wireless local area network technologies.

2. Related Art

A wireless local area network (WLAN) generally refers to a network in which devices communicate with each other over a wireless medium in conformity with IEEE 802.11 family of standards. As is well known, such technologies rely on an access point, which normally operates as a switching device to facilitate wireless stations to communicate with each other, and also potentially with devices external to a WLAN.

An end device refers to a device, which is either a source or destination of data, according to the 802.11 standards. A device may be viewed to be a source of data if the data is generated/formed in the device (contrasted with forwarding/switching of packets based on an address specified in network/MAC layers). A device is said to be a destination of data, if the data is received according to 802.11 standards, and is consumed within the device, such that the data is not thereafter forwarded to other devices according to 802.11 standards. Thus, an end device (with respect to a WLAN) is contrasted from traditional access points of IEEE 802.11, which are intended for the function of switching or forwarding packets.

Thus, in case the end device is a source of the data, such data originates at the end device (instead of being received with a packet header indicating that the packet is to be forwarded). In case the end device is a destination of the data, the data is consumed by the end device itself, thereby not requiring forwarding of the data to other devices over wireless networks.

There is a general need to provide connectivity to end devices using WLAN technologies at least since such connectivity can form the basis for various user applications.

### BRIEF DESCRIPTION OF THE VIEWS OF DRAWINGS

Example embodiments of the present invention will be described with reference to the accompanying drawings briefly described below.

FIG. 1 is a block diagram of an example environment in which several features of the present invention can be implemented.

FIG. 2 is a flowchart illustrating the manner in which an end device is able to communicate with a wireless station, in an embodiment of the present invention.

FIG. 3 is a block diagram illustrating the implementation details of an access point in an embodiment of the present invention.

The drawing in which an element first appears is indicated by the leftmost digit(s) in the corresponding reference number.

### DETAILED DESCRIPTION

### 1. Overview

A system includes a wireless station and an end device. The wireless station is designed to operate according to a wireless local area network (WLAN) protocol. The end device operates as an access point according to the WLAN protocol to setup communication with the wireless station, and thereafter exchanges data packets with the wireless station while operating as an access point.

In an embodiment, the end point includes a sensor to measure blood pressure, and transmits, while operating as an access point, the blood pressure measurements to a mobile phone designed to operate as a wireless station.

Several aspects of the invention are described below with reference to examples for illustration. It should be understood that numerous specific details, relationships, and methods are set forth to provide a full understanding of the invention. One skilled in the relevant arts, however, will readily recognize that the invention can be practiced without one or more of the specific details, or with other methods, etc. In other instances, well-known structures or operations are not shown in detail to avoid obscuring the features of the invention.

### 2. Example Environment

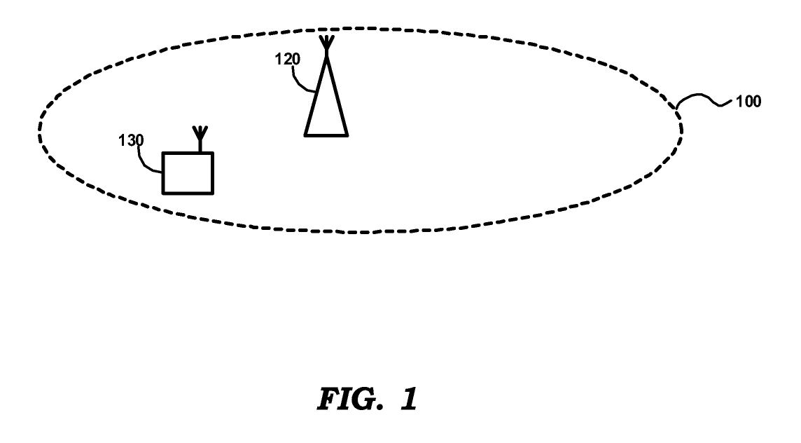

FIG. 1 is a block diagram of an example environment in which several features of the present invention can be implemented. WLAN 100 is shown containing end device 120 and wireless station 130. WLAN 100 represents an infrastructure basic service set (infrastructure BSS) according to the 802.11 standards. Wireless station 130 represents a device capable of communicating with other wireless stations (not shown) or other devices external to WLAN 100 via traditional access points provided in accordance with 802.11 standards.

End device 120 can either be a source or destination of data, though the illustrative embodiments described below are the source of data. In particular, end device 120 is assumed to be a sensor of a human-wearable tag for monitoring blood pressure of a person wearing the tag. Thus, the sensor measures the blood pressure of the person, and data representing the measured value is thereafter transmitted to wireless station 130, which can either further forward the data to other devices, or locally implement a user application which processes the received data suitably. End device 120 is not limited to a sensor. In other corresponding embodiments, end device 120 can be implemented, for example, as an actuator, etc.

Various aspects of the present invention enable such end devices to communicate with wireless stations, as described below with examples.

### 3. End Device Communication with Wireless Stations

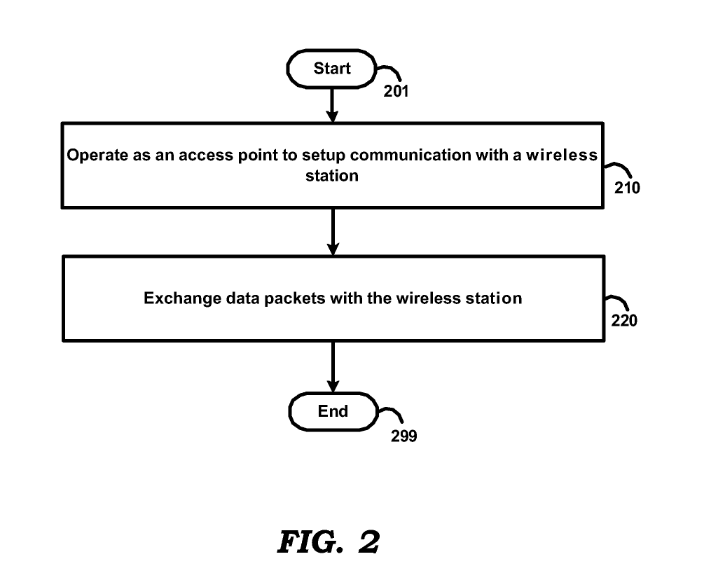

FIG. 2 is a flowchart illustrating the manner in which an end device is able to communicate with a wireless station, in an embodiment of the present invention. The flowchart is described with respect to the environment of FIG. 1 merely for illustration. However, various features described herein can be implemented in other environments as will be apparent to one skilled in the relevant arts by reading the disclosure provided herein. The flowchart starts in step 201, in which control passes immediately to step 210.

In step 210, end device 120 operates as an access point to setup communication with a wireless station. Setting up communication according to 802.11 standards may entail, for example, transmitting beacon messages such that wireless station 130 is made aware of the presence of end device 120 as an access point, and can thereafter associate with end device 120 as an access point. As an alternative, end device 120 may respond with a ‘probe response’ message to a ‘probe request’ message originating from wireless station 130 to cause similar association. As specified in 802.11 standards, once such association is established, a wireless station can exchange data packets with an access point. Control then passes to step 220.

In step 220, end device 120 exchanges data packets with wireless station 130 based on the communication thus setup. The implementation of such exchange of packets will be apparent to a skilled practitioner based on the disclosure provided herein. The flow chart thereafter ends in step 299, in which the communication may be terminated.

It may thus be appreciated that end device 120 is provided the capability to communicate with a large deployed base of wireless stations (e.g., mobile phones), which are implemented with the necessary capabilities to operate as wireless stations according to 802.11. Such communication can be the basis for many applications (e.g., a blood pressure monitoring application can be implemented within a mobile phone operating as a wireless station).

The capability is provided without having to use peer-to-peer networking capability (such as in an independent BSS provided by 802.11), which is observed to be deployed on a much smaller base of wireless stations.

The description is continued with respect to the details of an example end device, which implements the features described above with respect to FIG. 2.

### 4. End Device

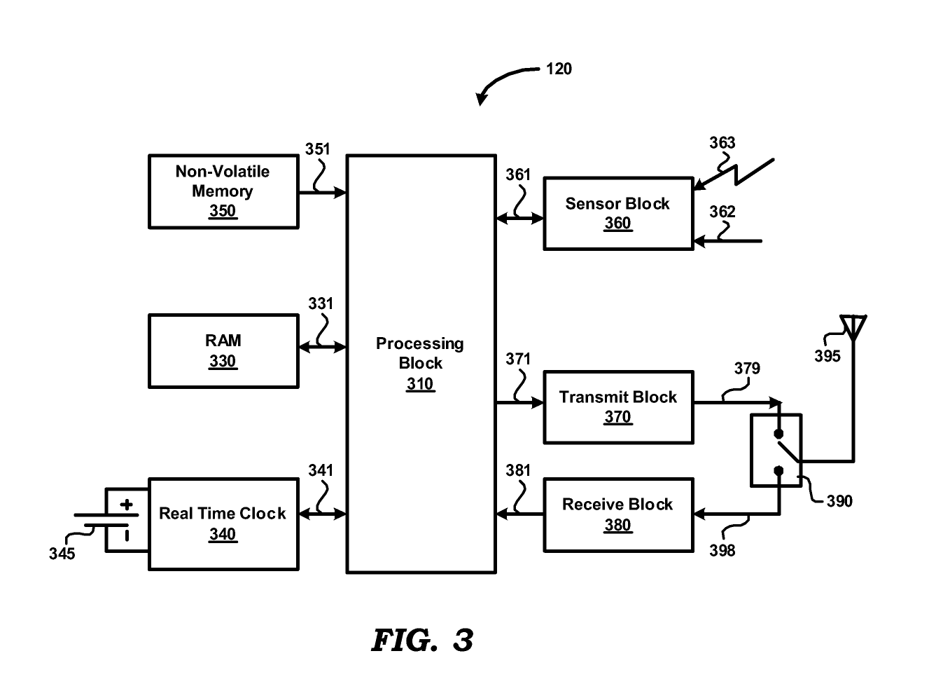

FIG. 3 is a block diagram illustrating the implementation details of an end device in an embodiment of the present invention. End device 120 is shown containing processing block 310, volatile memory (RAM) 330, real-time clock (RTC) 340, battery 345, non-volatile memory 350, sensor block 360, transmit block 370, receive block 380, switch 390 and antenna 395. The whole of end device 120 may be implemented as a system-on-chip (SoC), except for battery 345. Alternatively, the blocks of FIG. 3 may be implemented on separate integrated circuits (IC).

The components/blocks of end device 120 are shown merely by way of illustration. However, end device 120 may contain more or fewer components/blocks. Further, all blocks/components of end device 120 may be powered by battery 345, although only RTC 340 is shown in FIG. 3 as being powered by battery 345.

Sensor block 360 may contain one or more sensors, as well as corresponding signal conditioning circuitry, and provides on path 361 measurements/values of physical quantities such as temperature, pressure, etc., sensed via wired path 362 or wireless path 363. In an embodiment, sensor block 360 is a blood pressure sensor. It should be appreciated that data is created (contrasted to mere forwarding of data received from other wireless devices) to represent such measured values due to the operation of sensor block 360.

While sensor block 360 is shown integral to end device 120 (operating as an access point), in alternative embodiments, sensor block 360 may be implemented as a separate unit communicating with end device 120 using non-network protocols (i.e., does not contain a network/medium access control header portion which would specify the destination address). For example, the communication can be using RS-232 serial link on path 361.

Antenna 395 operates to receive from, and transmit to, a wireless medium corresponding wireless signals containing data. Switch 390 may be controlled by processing block 310 (connection not shown) to connect antenna 395 either to receive block 380 via path 398, or to transmit block 370 via path 379, depending on whether end device 120 is to receive or transmit. In another embodiment, the receive and transmit blocks each are connected to separate antennas to enable simultaneous reception and transmission.

Transmit block 370 receives data (to be transmitted via antenna 395) on path 371 from processing block 310, generates a modulated radio frequency (RF) signal according to IEEE 802.11 standards, and transmits the RF signal via switch 390 and antenna 395. Receive block 380 receives an RF signal bearing data via switch 390 and antenna 395, demodulates the RF signal, and provides the extracted data to processing block 310 on path 381.

RTC (Real time clock) 340 operates as a clock, and provides the ‘current’ time to processing block 310 on path 341. RTC 340 may also contain memory to store critical information received from processing block 310.

Non-volatile memory 350 stores instructions, which when executed by processing block 310, causes end device 120 to provide several features noted herein. For example, when end device 120 is implemented as a wearable tag to record (and transmit) blood pressure measurements, processing block 310 may process and transmit measurement blood pressure readings obtained from sensor block 360. In addition, the instructions may be designed to control other blocks of FIG. 3, which enable end device 120 to operate consistent with the description provided herein.

Thus, non-volatile memory 350 contains instructions and data to enable processing block 310 to establish communication and exchange packets, as described above with respect to the flowchart of FIG. 2. RAM 330 may be used to store data and temporary variables to be processed by processing block 310 in providing desired features. Volatile memory 330 and non-volatile memory 350 constitute computer program products or machine/computer readable medium, which are means for providing instructions to processing block 310.

Processing block 310 may contain multiple processing units internally, with each processing unit potentially being designed for a specific task. Alternatively, processing block 310 may contain only a single general-purpose processing unit. The instructions executed by processing block 310 enable end device 120 to perform the steps of the flowchart of FIG. 2. In particular, the processing may encode data representing blood pressure measurements (received from sensor block 360) in the payload portion of a WLAN packet, and send the packets in to wireless station 130, while operating as an access point. The MAC packet format used by end device 120 indicates that the packet is being transmitted from an AP. Specifically, the ‘From DS’ and ‘To DS’ bits in the ‘Frame Control’ field of the packet are respectively set to logic 1 and logic 0, indicating that the transmission is from an access point to a wireless station.

Thus, when operating as a blood pressure sensor, end device 120 may be able to communicate with a large number of mobile phones, which are implemented in conjunction with access points. Such communication can be the basis for implementation of various management applications on mobile phone type devices. In the example embodiment described herein, the blood pressure at various time instances can be measured using sensor 360 and sent to a mobile phone for display or further transmission via cellular networks, etc.

### 5. Conclusion

References throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. A system comprising:
a wireless station according to a wireless local area network (WLAN) protocol; and
an end device operating as an access point according to said WLAN protocol, in communicating with said wireless station.

2. The system of claim 1, wherein said end device is a source of data.

3. The system of claim 2, wherein said WLAN protocol is according to IEEE 802.11 standards.

4. The system of claim 3, wherein said end device comprises a sensor, wherein said end device includes data representing a magnitude of a parameter sensed by said sensor, in a payload portion of a packet sent to said wireless station,
wherein said end device sends said packet to said wireless station while operating as an access point according to said IEEE 802.11 standards.

5. The system of claim 4, wherein said sensor is integrated as into said end device as a single unit.

6. The system of claim 4, wherein said sensor is provided external to said end device, which sends said magnitude according to a convention in which said wireless station is not identified in a network or medium access control (MAC) layer headers.

7. The system of claim 4, wherein said sensor is a blood pressure sensor.

8. An end device comprising:
a sensor to sense a magnitude of a parameter;
a processor to provide data representing said magnitude; and
a transmit block to transmit said data encapsulated in the form of a packet on a wireless medium, wherein said packet includes data indicating that said end device is an access point.

9. The end device of claim 8, wherein said access point is specified according to IEEE 802.11 standards.

10. The end device of claim 9, wherein said sensor measures magnitude of blood pressure.

11. A method of communicating with a wireless station on a wireless local area network (WLAN), said method being implemented in an end device, said method comprising:
operating as an access point to setup communication with said wireless station; and
exchanging data packets with said wireless station while operating as said access point.

12. The method of claim 11, wherein each of said data packets comprises data in a header portion indicating that said end device is operating as said access point.

13. The method of claim 12, wherein said data packets, including said header portion, are according to IEEE 802.11 standards.

14. The method of claim 13, wherein said data packets comprises a packet sent from said end device to said wireless station, wherein said header portion indicates that said packet is being sent from said end device to said wireless station.

15. The method of claim 14, wherein the data in said packet represents a magnitude of a parameter measured by a sensor.
